(19) United States
(12) Patent Application Publication
(10) Pub. No.: US 2025/0192504 A1
(43) Pub. Date: Jun. 12, 2025

(54) HIGH-REPETITION-RATE FIBER LASER HAVING ULTRASHORT RESONANT CAVITY WITH TUNABLE REPETITION RATE

(71) Applicant: SOUTH CHINA UNIVERSITY OF TECHNOLOGY, Guangzhou (CN)

(72) Inventors: Xiaoming WEI, Guangzhou (CN); Lin LING, Guangzhou (CN); Xiaoxiao WEN, Guangzhou (CN); Wenlong WANG, Guangzhou (CN); Zhongmin YANG, Guangzhou (CN)

(73) Assignee: SOUTH CHINA UNIVERSITY OF TECHNOLOGY, Guangzhou (CN)

(21) Appl. No.: 18/843,271

(22) PCT Filed: Mar. 24, 2023
(86) PCT No.: PCT/CN2023/083582

§ 371 Date: Sep. 2, 2024

(30) Foreign Application Priority Data
Mar. 24, 2022 (CN) 202210297175.8

(51) Int. Cl. H01S 3/08; H01S 3/067; H01S 3/1118

(52) U.S. Cl. CPC H01S 3/08004; H01S 3/06708; H01S 3/1118

(57) ABSTRACT

The present invention discloses a high-repetition-rate fiber laser having an ultrashort resonant cavity with a tunable repetition rate, including a pump source, a wavelength division multiplexer, an optical isolator, and an ultrashort resonant cavity with a tunable repetition rate. The wavelength division multiplexer is configured to couple pump light generated by the pump source into the ultrashort resonant cavity with a tunable repetition rate and output generated signal light to the outside of the ultrashort resonant cavity with a tunable repetition rate, and the optical isolator is connected to the wavelength division multiplexer. The ultrashort resonant cavity with a tunable repetition rate includes a first graded-index lens, a second graded-index lens, a ferrule, a sleeve tube, a gain fiber, a semiconductor saturable absorber mirror, and a dielectric film.

### TECHNICAL FIELD

The present invention pertains to the field of high-repetition-rate passively mode-locked fiber lasers, and specifically relates to a high-repetition-rate fiber laser having an ultrashort resonant cavity with a tunable repetition rate.

### DESCRIPTION OF RELATED ART

A high-repetition-rate laser source has significant research value and application potential in various fields such as precise spectral measurement, high-speed optical sampling, high-quality optical communication, precise microfabrication, and nonlinear biological imaging. In addition, compared with solid lasers, semiconductor lasers, gas lasers, dye lasers, and the like, fiber lasers have outstanding advantages such as compact structure, low manufacturing cost, strong heat dissipation capability, and high pump conversion efficiency. These advantages make fiber lasers highly favored in scientific research and industrial processing, and become the preferred choice for studying high-reliability, high-pulse-quality laser sources.

Mode-locking is an important method for generating femtosecond ultrashort pulses, and passively mode-locked fiber lasers are the main device to generate high-repetition-rate ultrashort pulse laser beams. To enhance the practical application of passively mode-locked lasers, researchers have explored multiple dimensions to improve the performance of the lasers, for example, achieving shorter pulse width, higher output power, lower intensity noise, and tunable output wavelength. To meet the demands for different scenarios and applications, it is important to enable the repetition rate of an output laser pulse to be tunable when only a single laser is used to output multiple repetition frequencies.

According to the repetition rate formula

$$f = \frac{c}{2 nL}$$

of the laser, the length of the resonant cavity can be changed to achieve a tunable repetition rate. In 2004, B. R. Washburn and colleagues adjusted a repetition rate from 49.3 MHz to 50.1 MHz, with a change of 800 kHz, by incorporating fiber delay lines into an erbium doping fiber ring cavity (Washburn B, Fox R, Newbury N, et al. Fiber-laser-based frequency comb with a tunable repetition rate [J]. Optics Express, 2004, 12(20):4999-5004.). For a high-repetition-rate fiber laser with a fundamental repetition rate greater than 1 GHz, the length of the resonant cavity is limited to the centimeter scale. Thus, a change in the cavity length on the millimeter scale results in a change in the repetition rate on the scale of megahertz or even gigahertz. For a high-repetition-rate laser with an ultrashort resonant cavity, it is difficult to use the traditional method with fiber delay lines to achieve a small change of the resonant cavity.

### SUMMARY

To overcome the shortcomings of the prior art, an objective of the present invention is to provide a high-repetition-rate fiber laser having an ultrashort resonant cavity with a tunable repetition rate based on graded-index lenses. Two graded-index lenses are incorporated in the ultrashort resonant cavity and a distance between a first graded-index lens and a second graded-index lens is changed to change the length of the ultrashort resonant cavity, thus achieving a tunable repetition rate of the laser pulses output by the high-repetition-rate fiber laser.

To achieve the foregoing objective, the present invention is implemented using at least one of the following technical solutions.

A high-repetition-rate fiber laser having an ultrashort resonant cavity with a tunable repetition rate is provided, including a pump source, a wavelength division multiplexer, an optical isolator, and an ultrashort resonant cavity with a tunable repetition rate. The wavelength division multiplexer is configured to couple pump light generated by the pump source into the ultrashort resonant cavity with a tunable repetition rate and output generated signal light to the outside of the ultrashort resonant cavity with a tunable repetition rate, and the optical isolator is connected to the wavelength division multiplexer.

Further, the ultrashort resonant cavity with a tunable repetition rate includes a first graded-index lens, a second graded-index lens, a ferrule, a sleeve tube, a gain fiber, a semiconductor saturable absorber mirror, and a dielectric film.

The semiconductor saturable absorber mirror is disposed on a surface of one end of the first graded-index lens, the other end of the first graded-index lens is indirectly connected to one end of the second graded-index lens via the sleeve tube, the other end of the second graded-index lens is connected to one end of the ferrule, the dielectric film is disposed on a surface of the other end of the ferrule, and the gain fiber is located in the ferrule.

Further, the ultrashort resonant cavity with a tunable repetition rate includes a first graded-index lens, a second graded-index lens, a ferrule, a sleeve tube, a gain fiber, a semiconductor saturable absorber mirror, and a dielectric film.

The semiconductor saturable absorber mirror is disposed on a surface of one end of the ferrule, the other end of the ferrule is connected to one end of the first graded-index lens, the other end of the first graded-index lens is indirectly connected to one end of the second graded-index lens via the sleeve tube, the dielectric film is disposed on a surface of the other end of the second graded-index lens, and the gain fiber is located in the ferrule.

Further, the sleeve tube is disposed outside the first ferrule, the first graded-index lens, and the second graded-index lens.

Further, the ultrashort resonant cavity with a tunable repetition rate includes a first graded-index lens, a second graded-index lens, a first ferrule, a second ferrule, a first sleeve tube, a second sleeve tube, a third sleeve tube, a first gain fiber, a second gain fiber, a semiconductor saturable absorber mirror, and a dielectric film.

The semiconductor saturable absorber mirror is disposed on a surface of one end of the first ferrule, the other end of the first ferrule is connected to one end of the first graded-index lens via the second sleeve tube, the second graded-index lens is connected to the second ferrule via the third sleeve tube, the dielectric film is disposed on a surface of one end of the second ferrule, the other end of the first graded-index lens is indirectly connected to the second graded-index lens via the first sleeve tube, the first gain fiber is located in the first ferrule, and the second gain fiber is located in the second ferrule.

Further, collimated light is transmitted between the first graded-index lens and the second graded-index lens, and a change in distance between the first graded-index lens and the second graded-index lens does not affect a transmission trajectory of the collimated light therebetween, that is, a distance L₁ between the first graded-index lens and the second graded-index lens is adjusted, so as to adjust a total length L of the ultrashort resonant cavity.

Further, the ultrashort resonant cavity with a tunable repetition rate is a Fabry-Perot cavity.

Further, a reflectivity of the dielectric film for a generated laser beam is greater than 60%.

Further, a modulation depth of the semiconductor saturable absorber mirror is 1% to 10%.

Further, the gain fiber is a rare earth ion-doping fiber, and the doped rare earth includes one or more of erbium, ytterbium, thulium, and holmium.

Further, a length of the ultrashort resonant cavity with a tunable repetition rate is 1 cm to 10 cm.

Further, the pump source is a semiconductor single-mode laser.

Compared with the prior art, the present invention has the following beneficial effects:

In the present invention, the use of two graded-index lenses in the ultrashort resonant cavity changes the distance between the first graded-index lens and the second graded-index lens, to adjust the total length of the ultrashort resonant cavity, thereby changing the repetition rate of the pulses output by the high-repetition-rate laser. This meets different needs of people during use of high-repetition-rate lasers in various application scenarios, minimizes economic and time costs, and maximizes the efficient use of resources.

### BRIEF DESCRIPTION OF THE DRAWINGS

To describe the technical solutions in the embodiments of the present invention more clearly, the following briefly describes the accompanying drawings used in the embodiments. It should be understood that the accompanying drawings below only show some embodiments of this application, and thus should not be considered as a limitation to the scope. Those of ordinary skill in the art may further obtain other accompanying drawings based on these accompanying drawings without creative efforts.

FIG. 1 is a structural principle diagram of a high-repetition-rate fiber laser having an ultrashort resonant cavity with a tunable repetition rate according to the present invention.

FIG. 2 is a schematic structural diagram of an ultrashort resonant cavity with a tunable repetition rate according to Embodiment 1 of the present invention.

FIG. 3 is a schematic structural diagram of an ultrashort resonant cavity with a tunable repetition rate according to Embodiment 2 of the present invention.

FIG. 4 is a schematic structural diagram of an ultrashort resonant cavity with a tunable repetition rate according to Embodiment 3 of the present invention.

### DESCRIPTION OF THE EMBODIMENTS

The following clearly and completely describes the technical solutions in the embodiments of the present invention with reference to the accompanying drawings in the embodiments of the present invention. Apparently, the described embodiments are only some rather than all of the embodiments of the present invention. All other embodiments obtained by persons of ordinary skill in the art based on the embodiments of present invention without creative efforts shall fall within the protection scope of present invention.

In order to make the foregoing objective, features, and advantages of the present invention more clearly and easily understood, the technical solution of the present invention is further described below in detail with reference to the accompanying drawings and specific embodiments. It should be noted that the specific embodiments described herein are merely used to explain this application but are not intended to limit this application.

### Embodiment 1

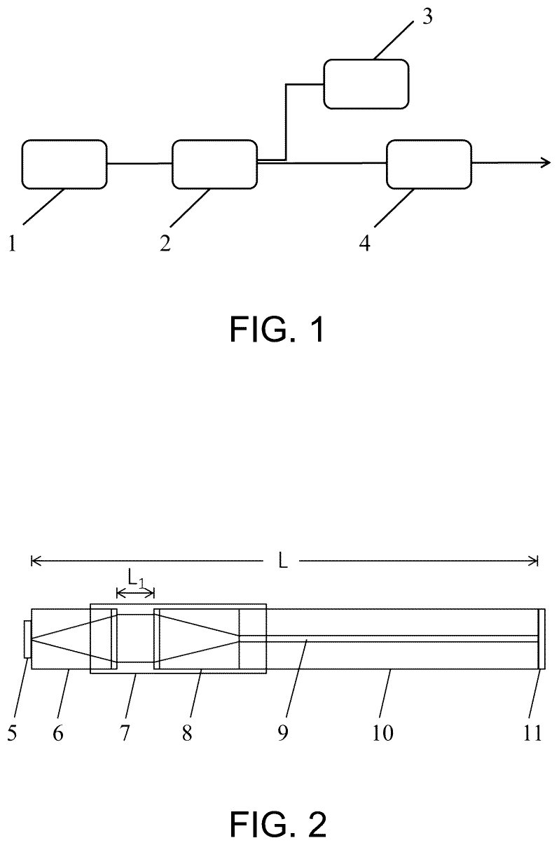

As shown in FIG. 1, this embodiment provides a high-repetition-rate fiber laser having an ultrashort resonant cavity with a tunable repetition rate, including a pump source 3, a wavelength division multiplexer 2, an optical isolator 4, and an ultrashort resonant cavity 1 with a tunable repetition rate. The wavelength division multiplexer 2 is configured to couple pump light generated by the pump source 3 into the ultrashort resonant cavity 1 with a tunable repetition rate and output generated signal light to the outside of the ultrashort resonant cavity 1 with a tunable repetition rate, and the optical isolator 4 is connected to the wavelength division multiplexer 2, to prevent the impact of back-reflected light.

As shown in FIG. 2, the ultrashort resonant cavity 1 with a tunable repetition rate includes a first graded-index lens 6, a second graded-index lens 8, a ferrule 10, a sleeve tube 7, a gain fiber 9, a semiconductor saturable absorber mirror 5, and a dielectric film 11.

The semiconductor saturable absorber mirror 5 is disposed on a surface of one end of the first graded-index lens 6. The other end of the first graded-index lens 6 is indirectly connected to one end of the second graded-index lens 8 via the sleeve tube 7, and the other end of the second graded-index lens 8 is connected to one end of the ferrule 10. The dielectric film 11 is disposed on a surface of the other end of the ferrule 10. The sleeve tube 7 is disposed outside the first ferrule 10, the first graded-index lens 6, and the second graded-index lens 8.

In practical application, the ultrashort resonant cavity is a Fabry-Perot cavity structure which is compact with a total length of less than 10 cm, achieving mode-locked pulse outputs with a repetition rate greater than 1 GHz, thus allowing for repetition rate adjustment on the scale of megahertz or even gigahertz.

The pump source 3 is a semiconductor single-mode laser with a central wavelength of 974 nm and a maximum pump power of 460 mW.

The dielectric film 7 is a dichroic dielectric film applied to a surface of one end of the ferrule 10 by a way of plasma sputtering. It has a high transmittance (greater than 80%) for pump light and a high reflectivity (greater than 80%) for signal light.

The semiconductor saturable absorber mirror 5 is fixed to a surface of one end of the first graded-index lens 2 and has a central wavelength of 1040 nm, an area of 1×1 mm, a thickness of 450 μm, a modulation depth of 5%, an unsaturated loss of 3%, a saturation fluence of 40 μJ/cm², a relaxation time of 1 ps, and a damage threshold of 3 mJ/cm².

The gain fiber 9, being a fiber doped with rare earth ions of ytterbium, is fixed in the ferrule 10 using an optical adhesive.

The ferrule 10 is a ceramic ferrule with an inner diameter of 125 μm which matches the cladding diameter of the gain fiber 9, and with an outer diameter of 2.5 mm which is equal to the outer diameters of the first graded-index lens 6 and the second graded-index lens 8. Both ends of the ferrule 10 need to be polished vertically.

The sleeve tube 7 is a ceramic sleeve tube with an inner diameter of 2.5 mm, matching the outer diameters of the ferrule 10, the first graded-index lens 6, and the second graded-index lens 8.

The first graded-index lens 6 and the second graded-index lens 8 affect the optical path by changing the refractive indices of the lenses themselves, where their refractive indices change radially. All optical paths within the lenses are the same, allowing for conversion of collimated light and light transmitted in the fiber. Therefore, the collimated light is transmitted between the first graded-index lens 6 and the second graded-index lens 8. Changing the distance between the two graded-index lenses does not change the transmission trajectory of light therebetween. The distance L₁ between the two graded-index lenses is changed to change the length L of the entire ultrashort resonant cavity. It can be known according to

$$f = \frac{c}{2 nL}$$

that changing the length of the ultrashort resonant cavity allows for adjustment of the laser repetition rate. When the change in distance between the two graded-index lenses is ΔL₁, the change in the laser repetition rate is

$$Δ f = \frac{c}{2 nL} - \frac{c}{2 n ( L + Δ {L}_{1} )}$$

(an increase in the cavity length) or

$$Δ f = \frac{c}{2 n ( L - Δ {L}_{1} )} - \frac{c}{2 nL}$$

(a decrease in the cavity length).

### Embodiment 2

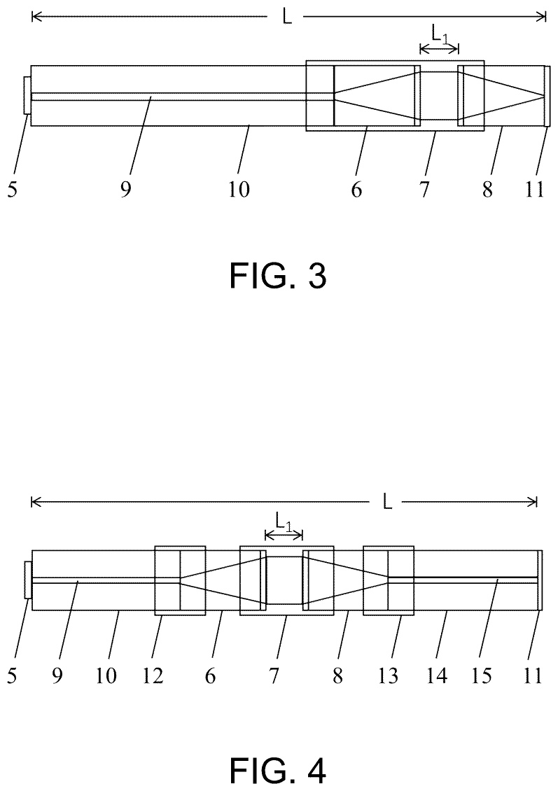

As shown in FIG. 3, an ultrashort resonant cavity 1 with a tunable repetition rate provided in this embodiment includes a first graded-index lens 6, a second graded-index lens 8, a ferrule 10, a sleeve tube 7, a gain fiber 9, a semiconductor saturable absorber mirror 5, and a dielectric film 11.

The ultrashort resonant cavity 1 with a tunable repetition rate in this embodiment and that in Embodiment 1 differ in that the semiconductor saturable absorber mirror 5 is disposed on a surface of one end of the ferrule 10, the other end of the ferrule 10 is connected to one end of the first graded-index lens 6, the other end of the first graded-index lens 6 is indirectly connected to one end of the second graded-index lens 8 via the sleeve tube 7, and the dielectric film 11 is disposed on a surface of the other end of the second graded-index lens 8.

In practical application, the pump source 3 is a semiconductor single-mode laser with a central wavelength of 976 nm and a maximum pump power of 480 mW.

The dielectric film 7 is a dichroic dielectric film applied to a surface of one end of the second graded-index lens 8 by a way of plasma sputtering. It has a high transmittance (greater than 80%) for pump light and a high reflectivity (greater than 80%) for signal light.

The semiconductor saturable absorber mirror 5 is fixed to a surface of one end of the first graded-index lens 2 and has a central wavelength of 1550 nm, an area of 1×1 mm, a thickness of 450 μm, a modulation depth of 4%, an unsaturated loss of 6%, a saturation fluence of 15 μJ/cm², a relaxation time of 5 ps, and a damage threshold of 1 mJ/cm².

The gain fiber 9, being a fiber doped with rare earth ions of both erbium and ytterbium, is fixed in the ferrule 10 using an optical adhesive.

### Embodiment 3

As shown in FIG. 4, an ultrashort resonant cavity 1 with a tunable repetition rate provided in this embodiment includes a first graded-index lens 6, a second graded-index lens 8, a first ferrule 10, a second ferrule 14, a first sleeve tube 7, a second sleeve tube 12, a third sleeve tube 13, a first gain fiber 9, a second gain fiber 15, a semiconductor saturable absorber mirror 5, and a dielectric film 11.

The ultrashort resonant cavity 1 with a tunable repetition rate in this embodiment and that in Embodiment 1 differ in that the semiconductor saturable absorber mirror 5 is disposed on a surface of one end of the first ferrule 10, the other end of the first ferrule 10 is connected to one end of the first graded-index lens 6 via the second sleeve tube 12, the second graded-index lens 8 is connected to the second ferrule 14 via the third sleeve tube 13, the dielectric film 11 is disposed on a surface of one end of the second ferrule 14, and the other end of the first graded-index lens 6 is indirectly connected to the second graded-index lens 8 via the first sleeve tube 7.

In practical application, the pump source 3 is a semiconductor single-mode laser with a central wavelength of 1570 nm and a maximum pump power of 500 mW.

The dielectric film 7 is a dichroic dielectric film applied to one end of the second ferrule 14 by a way of plasma sputtering. It has a high transmittance (greater than 80%) for pump light and a high reflectivity (greater than 80%) for signal light.

The semiconductor saturable absorber mirror 5 is fixed to a surface of one end of the first ferrule 10 and has a central wavelength of 2000 nm, an area of 1×1 mm, a thickness of 450 μm, a modulation depth of 12%, an unsaturated loss of 8%, a saturation fluence of 65 μJ/cm², a relaxation time of 10 ps, and a damage threshold of 2 mJ/cm².

The first gain fiber 9 and the second gain fiber 15, being fibers doped with rare earth ions of thulium, are respectively fixed in the first ferrule 10 and the second ferrule 14 using an optical adhesive.

The first ferrule 10 and the second ferrule 14 are both ceramic ferrules with an inner diameter of 125 μm which respectively matches the cladding diameters of the first gain fiber 9 and the second gain fiber 15, and with an outer diameter of 2.5 mm which is respectively equal to the outer diameters of the first graded-index lens 6 and the second graded-index lens 8. The first ferrule 10 and the second ferrule 14 each need to be polished vertically at two ends.

The first sleeve tube 7, the second sleeve tube 12, and the third sleeve tube 13 are all ceramic sleeve tubes with an inner diameter of 2.5 mm, matching the outer diameters of the first ferrule 10, the second ferrule 14, the first graded-index lens 6, and the second graded-index lens 8.

All embodiments in this specification are described in a progressive manner. Each embodiment focuses on differences from other embodiments. For the part that is the same or similar between different embodiments, reference may be made among the embodiments.

The above embodiments of the present invention are provided solely for illustrating the examples of the present invention and should not be considered as limitation on the implementation of the invention. For ordinary skilled persons in this field, additional changes or modifications in different forms can be made based on the above description. It is neither necessary nor feasible to exhaustively enumerate all possible embodiments herein. Any modification, equivalent replacement, improvement, or the like made without departing from the spirit and principle of the present invention shall fall within the protection scope of claims of the present invention.

1. A high-repetition-rate fiber laser having an ultrashort resonant cavity with a tunable repetition rate, wherein comprising a pump source, a wavelength division multiplexer, an optical isolator, and an ultrashort resonant cavity with a tunable repetition rate, the wavelength division multiplexer is configured to couple pump light generated by the pump source into the ultrashort resonant cavity with a tunable repetition rate and output generated signal light to the outside of the ultrashort resonant cavity with a tunable repetition rate, and the optical isolator is connected to the wavelength division multiplexer.

2. The high-repetition-rate fiber laser having an ultrashort resonant cavity with a tunable repetition rate according to claim 1, wherein the ultrashort resonant cavity with a tunable repetition rate comprises a first graded-index lens, a second graded-index lens, a first ferrule, a sleeve tube, a gain fiber, a semiconductor saturable absorber mirror and a dielectric film; wherein
the semiconductor saturable absorber mirror is disposed on a surface of one end of the first graded-index lens, the other end of the first graded-index lens is indirectly connected to one end of the second graded-index lens via the sleeve tube, the other end of the second graded-index lens is connected to one end of the first ferrule, the dielectric film is disposed on a surface of the other end of the first ferrule, and the gain fiber is located in the first ferrule.

3. The high-repetition-rate fiber laser having an ultrashort resonant cavity with a tunable repetition rate according to claim 1, wherein the ultrashort resonant cavity with a tunable repetition rate comprises a first graded-index lens, a second graded-index lens, a first ferrule, a sleeve tube, a gain fiber, a semiconductor saturable absorber mirror, and a dielectric film; wherein
the semiconductor saturable absorber mirror is disposed on a surface of one end of the first ferrule, the other end of the first ferrule is connected to one end of the first graded-index lens, the other end of the first graded-index lens is indirectly connected to one end of the second graded-index lens via the sleeve tube, the dielectric film is disposed on a surface of the other end of the second graded-index lens, and the gain fiber is located in the first ferrule.

4. The high-repetition-rate fiber laser having an ultrashort resonant cavity with a tunable repetition rate according to claim 2, wherein the sleeve tube is disposed outside the first ferrule, the first graded-index lens, and the second graded-index lens.

5. The high-repetition-rate fiber laser having an ultrashort resonant cavity with a tunable repetition rate according to claim 1, wherein the ultrashort resonant cavity with a tunable repetition rate comprises a first graded-index lens, a second graded-index lens, a first ferrule, a second ferrule, a first sleeve tube, a second sleeve tube, a third sleeve tube, a first gain fiber, a second gain fiber, a semiconductor saturable absorber mirror, and a dielectric film; wherein
the semiconductor saturable absorber mirror is disposed on a surface of one end of the first ferrule, the other end of the first ferrule is connected to one end of the first graded-index lens via the second sleeve tube, the second graded-index lens is connected to the second ferrule via the third sleeve tube, the dielectric film is disposed on a surface of one end of the second ferrule, the other end of the first graded-index lens is indirectly connected to the second graded-index lens via the first sleeve tube, the first gain fiber is located in the first ferrule, and the second gain fiber is located in the second ferrule.

6. The high-repetition-rate fiber laser having an ultrashort resonant cavity with a tunable repetition rate according to claim 2, wherein collimated light is transmitted between the first graded-index lens and the second graded-index lens, and a change in distance between the first graded-index lens and the second graded-index lens does not affect a transmission trajectory of the collimated light therebetween, that is, a distance L₁ between the first graded-index lens and the second graded-index lens is adjusted, so as to adjust a total length L of the ultrashort resonant cavity.

7. The high-repetition-rate fiber laser having an ultrashort resonant cavity with a tunable repetition rate according to claim 1, wherein the ultrashort resonant cavity with a tunable repetition rate is a Fabry-Perot cavity.

8. The high-repetition-rate fiber laser having an ultrashort resonant cavity with a tunable repetition rate according to claim 2, wherein a reflectivity of the dielectric film for a generated laser beam is greater than 60%.

9. The high-repetition-rate fiber laser having an ultrashort resonant cavity with a tunable repetition rate according to claim 2, wherein a modulation depth of the semiconductor saturable absorber mirror is 1% to 10%.

10. The high-repetition-rate fiber laser having an ultrashort resonant cavity with a tunable repetition rate according to claim 2, wherein the gain fiber is a rare earth ion-doping fiber, and the doped rare earth comprises one or more of erbium, ytterbium, thulium, and holmium.

11. The high-repetition-rate fiber laser having an ultrashort resonant cavity with a tunable repetition rate according to claim 3, wherein the sleeve tube is disposed outside the first ferrule, the first graded-index lens, and the second graded-index lens.

12. The high-repetition-rate fiber laser having an ultrashort resonant cavity with a tunable repetition rate according to claim 3, wherein collimated light is transmitted between the first graded-index lens and the second graded-index lens, and a change in distance between the first graded-index lens and the second graded-index lens does not affect a transmission trajectory of the collimated light therebetween, that is, a distance L₁ between the first graded-index lens and the second graded-index lens is adjusted, so as to adjust a total length L of the ultrashort resonant cavity.

13. The high-repetition-rate fiber laser having an ultrashort resonant cavity with a tunable repetition rate according to claim 4, wherein collimated light is transmitted between the first graded-index lens and the second graded-index lens, and a change in distance between the first graded-index lens and the second graded-index lens does not affect a transmission trajectory of the collimated light therebetween, that is, a distance L₁ between the first graded-index lens and the second graded-index lens is adjusted, so as to adjust a total length L of the ultrashort resonant cavity.

14. The high-repetition-rate fiber laser having an ultrashort resonant cavity with a tunable repetition rate according to claim 5, wherein collimated light is transmitted between the first graded-index lens and the second graded-index lens, and a change in distance between the first graded-index lens and the second graded-index lens does not affect a transmission trajectory of the collimated light therebetween, that is, a distance L₁ between the first graded-index lens and the second graded-index lens is adjusted, so as to adjust a total length L of the ultrashort resonant cavity.

15. The high-repetition-rate fiber laser having an ultrashort resonant cavity with a tunable repetition rate according to claim 11, wherein collimated light is transmitted between the first graded-index lens and the second graded-index lens, and a change in distance between the first graded-index lens and the second graded-index lens does not affect a transmission trajectory of the collimated light therebetween, that is, a distance L₁ between the first graded-index lens and the second graded-index lens is adjusted, so as to adjust a total length L of the ultrashort resonant cavity.
